(19) United States
(12) Patent Application Publication
(10) Pub. No.: US 2009/0103886 A1
(43) Pub. Date: Apr. 23, 2009

(54) SAME SCENE DETECTION METHOD, DEVICE, AND STORAGE MEDIUM CONTAINING PROGRAM

(75) Inventor: Mitsuteru Kataoka, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 11/917,183

(22) PCT Filed: Jun. 26, 2006
(86) PCT No.: PCT/JP2006/312693

§ 371 Date: Dec. 11, 2007

(30) Foreign Application Priority Data
Jun. 27, 2005 (JP) 2005-185850

(51) Int. Cl. H04N 5/93

(52) U.S. Cl. 386/52; 386/E05.001

(57) ABSTRACT

A same scene detecting apparatus includes comparison video storing unit that stores video and audio, video comparing unit that detects same scenes having same contents, and loop detecting unit that detects repeated appearance of the same scenes. With this configuration, when a user watches video and audio including same scenes or video and audio in which same scenes appear repeatedly, by detecting a loop, portions which are not overlapped can be selectively presented to the user.

### TECHNICAL FIELD

The present invention relates to an apparatus for presenting a user with video and audio including overlapped parts in an apparatus for processing information received by a digital TV.

### BACKGROUND ART

Japanese Patent Unexamined Publication No. 2001-249874 relates to software for detecting an update of Web pages on Internet by touring the Web pages. Such software is generally called “tour soft”. In particular, Japanese Unexamined Patent Application Publication No. 2001-249874 discloses a technique that highlights only updated parts on one Web page by changing font, color or the like of the updated parts.

Japanese Patent Unexamined Publication No. 1-202992 relates to a teletext system that transmits news and so on using character information overlapping with a television signal. This publication discloses a technique for detecting an update of contents and informing a user of the detected update by turning on a lamp attached to a television receiver or sounding an alarm.

Japanese Patent Unexamined Publication No. 2004-318389 relates to a bookmark list loaded on a Web browser which is software for displaying a Web page. This publication discloses a method of examining whether or not a Web page registered with a bookmark list is updated by automatically touring and referring to Web pages by use of software, and adding an update, which is made when a bookmark is indicated, to a display.

To make a difference between the invention and a prior technique distinct, a configuration of a conventional digital TV close to an embodiment of the invention will be described.

FIG. 19 is a view showing a configuration of a conventional digital TV. As shown in FIG. 19, digital TV 1900 includes antenna 1901, receiving unit 1902, decoding unit 1903, EPG (Electronic Program Guide) data storing unit 1904, input unit 1905, controller 1906, OSD generating unit 1907 and display unit 1908.

Antenna 1901 converts a radio wave of broadcasting into a high frequency signal. Receiving unit 1902 receives the high frequency signal outputted from antenna 1901, and demultiplexes the received high frequency signal into digital signals including video, audio, additional information such as EPG data, etc. Receiving unit 1902 may include a digital tuner module and a transport decoder of MPEG2-TS (Motion Picture Expert Group2-Transport Stream). MPEG2-TS is defined by international standard ISO/IEC13818-1.

Decoding unit 1903 receives video and audio data outputted from receiving unit 1902 and decodes the received data into electrical signals of video and audio to be presented to a user. If the video and audio data outputted from receiving unit 1902 has a format of MPEG2, decoding unit 1903 may be an MPEG2 decoder.

EPG data storing unit 1904 stores EPG data outputted from receiving unit 1902 and may be a secondary storage medium such as a semiconductor memory or a hard disk.

Input unit 1905 receives a physical manipulation from a user and converts it into an electrical signal. Input unit 1905 may be a remote controller and its light receiving unit, an electrical switch attached to a body of the digital TV, a keyboard, a pointing device such as a mouse, a microphone, a voice recognition device or the like.

Controller 1906 controls the digital TV as a whole and processes interaction of a user with a GUI (Graphic User Interface) that changes a graphic video (OSD: On Screen Display) displayed on a screen according to a user's manipulation inputted from input unit 1905. Controller 1906 may be a microcomputer including a CPU (Central Processing Unit), a semiconductor memory and so on.

OSD generating unit 1907 draws a graphics or a character font for an internal frame memory according to a drawing instruction from controller 1906 and outputs a graphic video made in the internal frame memory, as an electrical signal, to display unit 1908.

Display unit 1908 receives the electrical video and audio signals from decoding unit 1903 and the graphic video from OSD generating unit 1907 and converts them into light and sound which are a physical phenomenon and are perceivable by a user. Display unit 1908 may be a plasma display panel or a liquid crystal display panel, and a speaker.

Next, an example of a screen presented to a user in display unit 1908 of the conventional apparatus will be described.

FIG. 20 is a view showing an entire program table provided by the conventional apparatus. As shown in FIG. 20, a program table 2000 is displayed with arrangement similar to a program section in a newspaper. Here, columns in a horizontal direction represent a transmission path (broadcasting channel) through which contents (programs) are transmitted. A vertical direction represents a time axis. Each of rectangular forms in a middle portion represents one program defined by EPG data as original data composing the program table. Each of character strings representing titles of programs is indicated in each frame. In FIG. 20, the character strings are not shown for the sake of brevity, except for program 2001.

Here, attention is paid to program 2001. Since program 2001 is defined as one long program in EPG data, it is indicated as one rectangle. However, it is not guaranteed that program 2001 is one long program from a standpoint of actual video and audio perceivable by a user.

Accordingly, for example, the same program may be repeatedly broadcast in program 2001, like a Near VOD (Video On Demand) or a promotion•channel of a broadcasting station.

In some cases, there may be rebroadcast the same programs at different times on the same day, or on different days. In some cases, like a terrestrial analog broadcasting and a terrestrial digital broadcasting of the same broadcasting station, the same programs may be simultaneous-broadcast at the same time through different transmission paths (broadcasting channels). EPG data indicating that the same programs are identical with each other may not be transmitted, or data format representing the identity of the same programs may not be defined.

For example, in a music broadcasting station or the like, in many cases, programs (music) may not be transmitted as different programs.

In a broadcasting for disaster situation hastily broadcast immediately after outbreak of a disaster, only video and audio may be broadcast for disaster situation, with EPG data as a typical program before outbreak of the disaster. In addition, the same video and audio may be repeatedly streamed.

In addition, in a broadcasting station using a broadband technique on Internet for transmission, one transmission path specified by URI (Uniform Resource Identifier) or the like may be one content. One or several contents may be repeatedly transmitted. Since information corresponding to EPG data divided for each of contents is not sufficiently provided, or a format corresponding to original EPG data is not defined, there may be a possibility that starting time of contents is unknown.

### SUMMARY OF THE INVENTION

As described above, although contents (programs) such as actual video and audio are repeatedly transmitted, there may occur situations where starting time of heads of repetition of contents is not obtained from EPG data. IN such situations, problems of the conventional techniques are as follows.

(1) Considering a case where contents including the same scenes or contents in which the same scenes appear repeatedly are watched, if meta data such as program table data are insufficient, a user does not know where the same scenes are overlapped until all of the contents are watched. Accordingly, the user may watch the same scenes several times, spending time wastefully, or may overlook scenes which are not overlapped. In addition, although a fast wind playback allows some reduction of time, the fast wind playback increases troublesomeness in manipulation by a user.

(2) Considering a case where a user is watching a broadcasting channel through which the same contents are repeatedly transmitted and the contents are irregularly updated, the user who tries to watch the updated contents is forced to watch the same contents several times for a long time.

(3) Considering a case where contents transmitted in real time through a plurality of transmission paths can be received, the same contents are repeatedly transmitted through each of the plurality of transmission paths, and the contents are irregularly updated, a user has to change the plurality of transmission paths in sequence to confirm whether or not new contents streams in order to obtain all contents streaming in all the transmission paths. In case of Internet Web pages, since contents have a file format, it is possible to quickly determine whether or not the contents are updated by comparing files, the number of bytes of files, or time stamps of files. However, videos and audios have no distinction, and thus update of videos and audio has to resort to man power.

(4) Considering a case where a plurality of episodes in a serial drama are arranged, stored and decoded, a user is forced to watch the same opening or ending, or the same CM (commercial message) every time, spending time wastefully. Although conventional apparatuses have a function such as a CM skip function of 30 second fast forward, this function requires extra manipulation. Since opening time may not be a multiple of 30 seconds, some of a main part may be deleted or overlapping portions may not be completely skipped.

(5) Considering a case where the same contents repeatedly transmitted are stored for a long time and then decoded, if contents are updated in the course of storage, a user has to repeat an operation such as fast forward or rewind at the sight of a screen in order to set head of the contents to a start position of the contents, giving troublesomeness to the user. In addition, the updated contents may result in not being stored, consuming useless efforts.

(6) Considering a case where the overlapped same a plurality of scenes and contents is included in stored contents, a user spends much time in watching the contents and a storage area is spent wastefully.

(7) Considering a case where the same contents are repeatedly transmitted, but time information included in EPG data does not correspond to each repetition, a user who tries to store contents amounting to one round has to determine a timing at which the content starts, store the contents at the determined timing, and stop the storage at the end of one round. Such manipulation is troublesome, and if a manipulation timing is incorrect, some of the stored contents may be lost, or an unnecessary portion may be stored, spending a storage area wastefully.

According to a same scene detecting method of the invention, same scenes of scenes, which are temporal parts of video or audio and are perceived to be identical with each other by a user, are detected, and the detected same scenes are extracted as a set of same scenes. Next, a difference between appearance times of the same scenes included in the set of same scenes is obtained. Then, a set of same scenes having similar appearance times as a same region, with the difference of the set of same scenes being close to the same scenes, is selected. Then, if the sum of time lengths of the same scenes included in the same region exceeds a predetermined value, it is determined that the same region is a scene loop having the difference as an appearance period. Then, the obtained periodicity is presented to the user.

According to the same scene detecting method of the invention, when a user watches contents including same scenes or contents in which same scenes appear repeatedly, the user can known at the sight of screen display which portions of contents are overlapped and where contents are circulated, without actually watching videos and audios. Accordingly, the user can find a portion that he/she wishes to watch in a short time, thereby saving time taken to search contents.

### BRIEF DESCRIPTION OF THE DRAWINGS

FIG. 1 is a view showing a configuration of a same scene detecting apparatus according to a first embodiment of the invention.

FIG. 2 is a flow chart of a process of generation of same region information according to the first embodiment of the invention.

FIG. 3 is a view showing an example of search information according to the first embodiment of the invention.

FIG. 4 is a view showing an example of broadcast schedule information according to the first embodiment of the invention.

FIG. 5 is a view showing an example of the same region information according to the first embodiment of the invention.

FIG. 6 is a flow chart of a process of generation of loop information according to the first embodiment of the invention.

FIG. 7 is a flow chart of a merge process of loop information according to the first embodiment of the invention.

FIG. 8 is a view showing an example of loop information according to the first embodiment of the invention.

FIG. 9 is a view showing an example of screen display according to the first embodiment of the invention.

FIG. 10 is a view showing an example of display of the same contents according to the first embodiment of the invention.

FIG. 11 is a view showing an example of display of a program table according to the first embodiment of the invention.

FIG. 12 is a view showing an example of a notification screen of content update according to a second embodiment of the invention.

FIG. 13 is a flow chart of a process of detection of content update according to the second embodiment of the invention.

FIG. 14 is a flow chart of a process of automatic touring for a plurality of transmission paths according to a third embodiment of the invention.

FIG. 15 is a flow chart of a process of automatic overlapping skip and decoding according to a fourth embodiment of the invention.

FIG. 16 is a flow chart of a process of manual skip decoding according to a fifth embodiment of the invention.

FIG. 17 is a flow chart of a process of deletion edition of overlapping scenes according to a sixth embodiment of the invention.

FIG. 18 is a flow chart of a process of automatic storage stop according to a seventh embodiment of the invention.

FIG. 19 is a view showing a configuration of a conventional apparatus.

FIG. 20 is a view showing screen display of the conventional apparatus.

### DESCRIPTION OF REFERENCE NUMERALS AND SIGNS

100: SAME SCENE DETECTING APPARATUS
101: COMPARISON VIDEO STORING UNIT
102: VIDEO COMPARING UNIT
103: LOOP DETECTING UNIT
104: CONTROLLER
105: ANTENNA
106: RECEIVING UNIT
107: DECODING UNIT
108: INPUT UNIT
109: OSD GENERATING UNIT
110: DISPLAY UNIT

### PREFERRED EMBODIMENTS FOR CARRYING OUT THE INVENTION

### First Embodiment

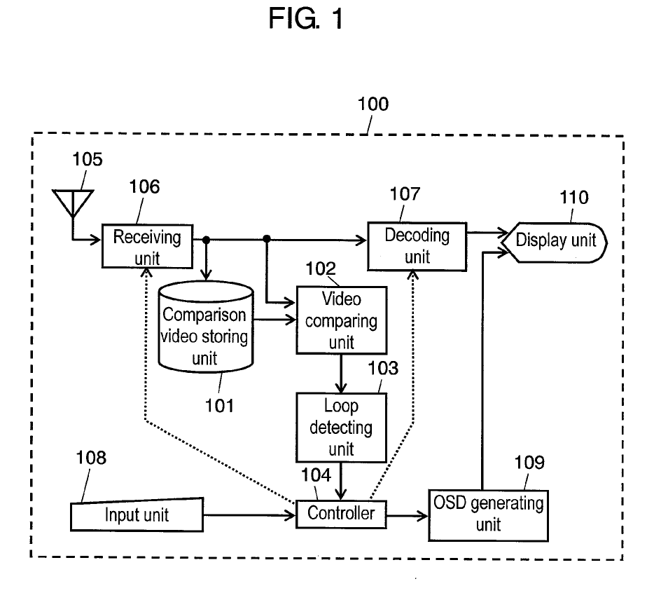

A first embodiment of the invention will be described with reference to FIGS. 1 to 11.

FIG. 1 is a view showing a configuration of a same scene detecting apparatus according to a first embodiment of the invention. As shown in FIG. 1, a same scene detecting apparatus 100 includes antenna 105, receiving unit 106, decoding unit 107, input unit 108, OSD generating unit 109, display unit 110, comparison video storing unit 101, video comparing unit 102, loop detecting unit 103 and controller 104.

Hereinafter, the like components are denoted by the like reference numerals throughout the drawings, and description thereof will be omitted. Alphabet 1 character is added to the end of a plurality of like components shown in the same figure.

Antenna 105 converts a radio wave of broadcasting into a high frequency signal. Receiving unit 106 receives the high frequency signal outputted from antenna 105, and demultiplexes the received high frequency signal into digital signals including video, audio, additional information such as EPG data, etc. Decoding unit 107 receives video and audio data outputted from receiving unit 106 and decodes the received data into electrical signals of video and audio to be presented to a user. Input unit 108 receives a physical manipulation from a user and converts it into an electrical signal.

OSD generating unit 109 draws a graphics or a character font for an internal frame memory according to a drawing instruction from controller 104 and outputs a graphic video made in the internal frame memory, as an electrical signal, to display unit 110. Display unit 110 receives the electrical video and audio signals from decoding unit 107 and the graphic video from OSD generating unit 109 and converts them into light and sound which are a physical phenomenon and are perceivable by a user.

Comparison video storing unit 101 stores the video and audio from the receiving unit 106. In comparison video storing unit 101, the video and audio may be stored in a manner to be decoded in decoding unit 107, or only data sufficient to determine whether or not two videos or audios are identical with each other may be stored.

For example, temporal frequency at which a still video or audio is sampled may be reduced. Resolution of video or the number of bits of audio may be reduced. Only luminance information of video or only a single channel of audio may be used. Only a particular color of video or only a particular frequency of audio may be used. A bit rate in a compressed format of video and audio may be used. Various parameters obtained intermediately in an encoder when video and audio are encoded with a compressed format. A histogram distribution of luminance of video or a frequency spectrum distribution or volume of audio may be used.

Comparison video storing unit 101 includes a component to converting particular data into data sufficient to determine whether or not two videos or audios are identical with each other, and a component of a passive storage medium such as a semiconductor memory or a hard disk. The former component may be an encoder such as MPEG2. Alternatively, if the former component stores output of receiving unit 106 as it is, it may be a passive storage medium such as semiconductor memory or a hard disk.

Video comparing unit 102 determines whether or not a plurality of videos or audios is identical with each other in users perception. Video comparing unit 102 determines whether or not a plurality of videos or audios stored in comparison video storing unit 101 is identical with each other, or videos or audios from receiving unit 106 are identical with each other, and outputs a result of the determination. At the time of outputting the result of the determination, video comparing unit 102 also outputs information indicating that video and audio at which time interval in which transmission path are identical with video and audio at a different time interval in that transmission path.

If video and audio are in a compressed format, or are once converted into an analog signal and then converted into digital data by an A/D converter, there is a possibility that many portions are different from each other in comparison between data bits. Even in this case, a user may perceive that presented videos or audios are identical with each other. Video comparing unit 102 decides that videos or audios are identical with each other if the user perceives that videos or audios are identical with each other although it is determined that videos or audios are different from each other in comparison between data bits.

As one of methods of comparing videos or audios, there is a method of comparing a plurality of videos using a histogram of luminance or color or change of a bit rate of a compressed format and a method of comparing a plurality of audios using volume change or a histogram of a frequency spectrum.

A difference between videos or audios may be acceptable to a certain degree, or may be outputted as a parameter indicating certainty.

For example, in an opening of a serial drama, telops of actors, episode numbers or titles in a video may be different from each other. In an ending of the serial drama, some of the video in the serial drama this time may be reused. In addition, indication of a CM sponsor may be different. For audio, an audio streamed behind an opening video may be different. A performance effect such as deviation for several seconds between audios or videos may be carried out.

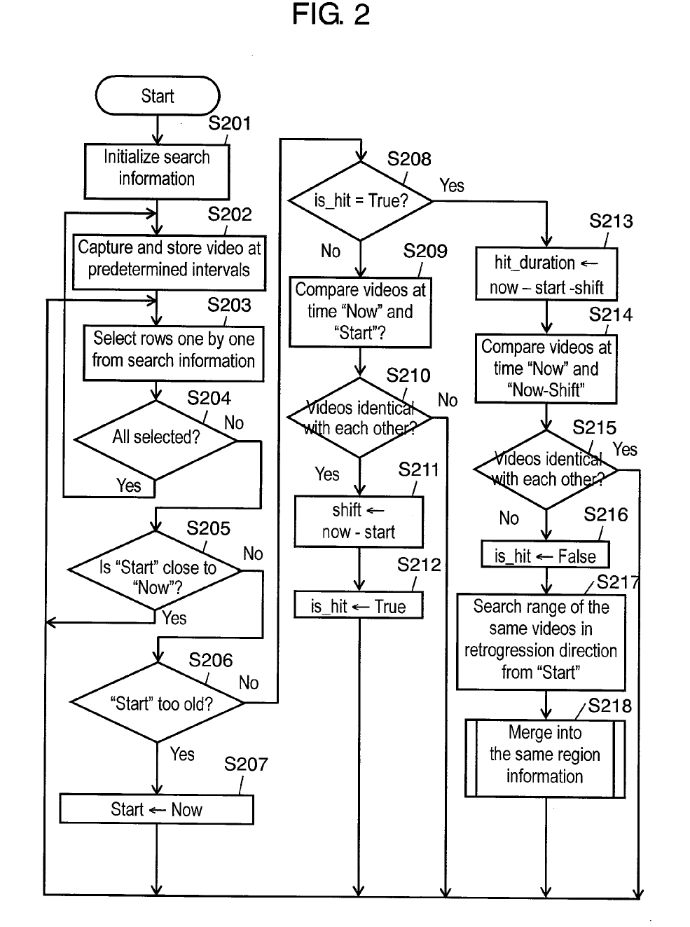

Next, an operation of video comparing unit 102 will be described with reference to FIG. 2. FIG. 2 is a flow chart of a process of generation of same region information by video comparing unit 102 according to the first embodiment of the invention. The same region refers to a temporal portion (region) of video or audio perceivable by a user with no difference.

Search information is initialized (Step S201). The search information is data indicating if videos or audios at which time are next compared in video comparing unit 102.

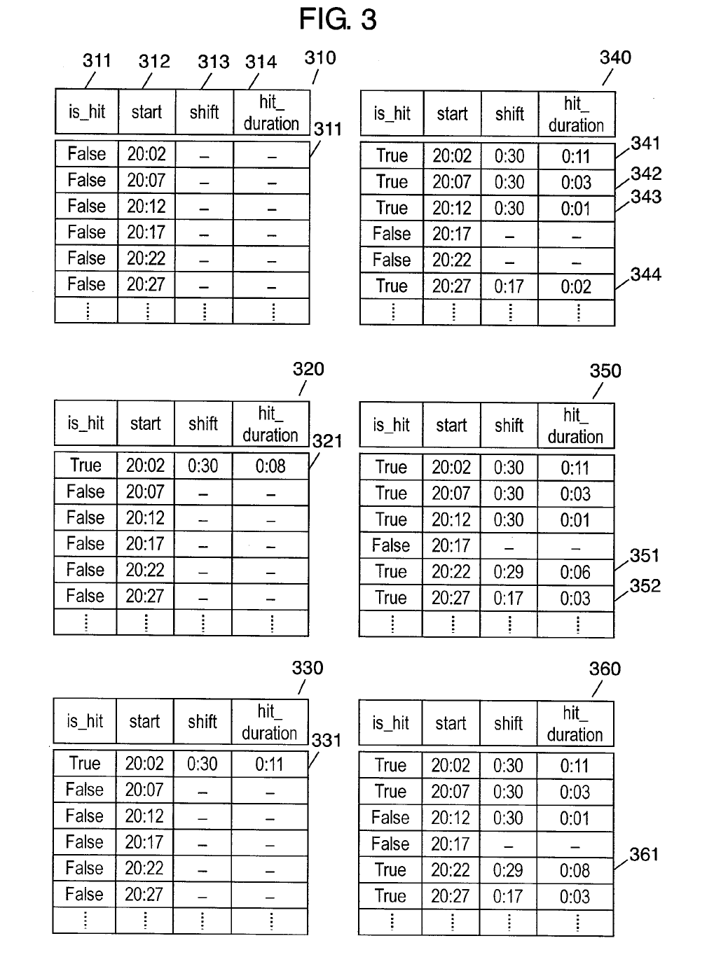

Next, the search information will be described in detail with reference to FIG. 3.

FIG. 3 is a view showing an example of search information at any point of time according to the first embodiment of the invention. As shown in FIG. 3, search information 310 is an example of search information initialized in Step S201. Search information 310 has a table format. Each row stores times at which search for video and audio is to be made. The row include a column of is_hit 311, a column of start 312, a column of shift 313 and a column of hit_duration 314.

The column of is_hit 311 stores a value indicating if it is determined by search corresponding to this row whether or not videos or audios are identical with each other.

The column of start 312 stores a head of search time for videos or audios.

The column of shift 313 stores a temporal difference with another time to be compared in video or audio of interest. That is, if it is determined that a time (start) is identical with a time (start+shift) in comparison therebetween, a value is put in the column of start 313. If the column of is_hit 311 is False, since it is determined that the time (start) is not identical with the time (start+shift), a value stored in the column of shift 313 has no meanings. In FIG. 3, values having no meanings are indicated by a cross line for the sake of convenience.

The column of hit_duration 314 indicates that it is determined that a time (start+a) is identical with a time (start+shift+a) when a assumes a value between 0 and hit_duration in video or audio of interest. The column of hit_duration 314 has no meanings if the column of is_hit 311 has a false value. In FIG. 3, values having no meanings are indicated by a cross line for the sake of convenience. For efficient process, it is not necessary to determine that the time (start+α) is identical with the time (start+shift+α) only when a assumes all values between 0 and hit_duration. That is, it may be determined that the time (start+α) is identical with the time (start+shift+α) when a is one of values discrete at predetermined time intervals.

Comparison video storing unit 101 captures videos and audios from receiving unit 106 at predetermined intervals and stores the captured videos and audios (Step S202). All frames of the videos and audios may be stored, or the videos and audios may be stored with predetermined time intervals. Alternatively, the videos and audios may be stored at temporal positions defined by a unique data structure having a compressed format, such as GOP (Group Of Picture) of MPEG2 Video.

Rows are selected one by one from the search information (Step S203). That is, rows of the search information are selected entry by entry (row by row) in order in Step S203.

In Step S203, since selection of all entries from the search information is completed, the process returns to Step S202 if there is no entry to be selected in Step S203 (Step S204) which is immediately before performed.

If “start” of an entry of the search information, which is selected in Step S203, is close to a current time “now”, the process returns to Step S203 (Step S205). If “start” and “now” do not have a sufficient time interval, for example when the same video lasts for a relatively long time, there is a possibility of making a nonsense determination of self-identity. Conditional determination in Step S205 is introduced to alleviate such a possibility.

The process proceeds to Step S207 if “start” is too elder than a predetermined time and, otherwise, proceeds to Step S208 (Step S206).

The aim of introducing this conditional determination is to limit a region in which the search information stored to below the maximum storable size by limiting the number of entries of the search information to below a predetermined number, and to prevent a process speed of video comparing unit 102 from being lower than a predetermined speed. If the number of entries of the search information is constant, it may be determined whether or not a time is elder than the product of an interval of “start” of each entry and the number of entries, such that “starts” of entries of the search information are arranged with a substantially equal interval.

“now” is put in “start”. Then, the process returns to Step S203 (Step S207). In Step S206, since it is determined that “start” is too old, that is, has no meanings, a value of “start” is again set to be a proper value.

The process proceeds to Step S213 if is_hit is True, and, otherwise, proceeds to Step S209 (Step S208).

Video comparing unit 102 compares two times of “now” and “start” and determines whether or not input videos or audios are identical with each other (Step S209).

The process proceeds to Step S211 if it is determined in Step S209 that the input videos or audios are identical with each other, and, otherwise, proceeds to Step S203 (Step S210).

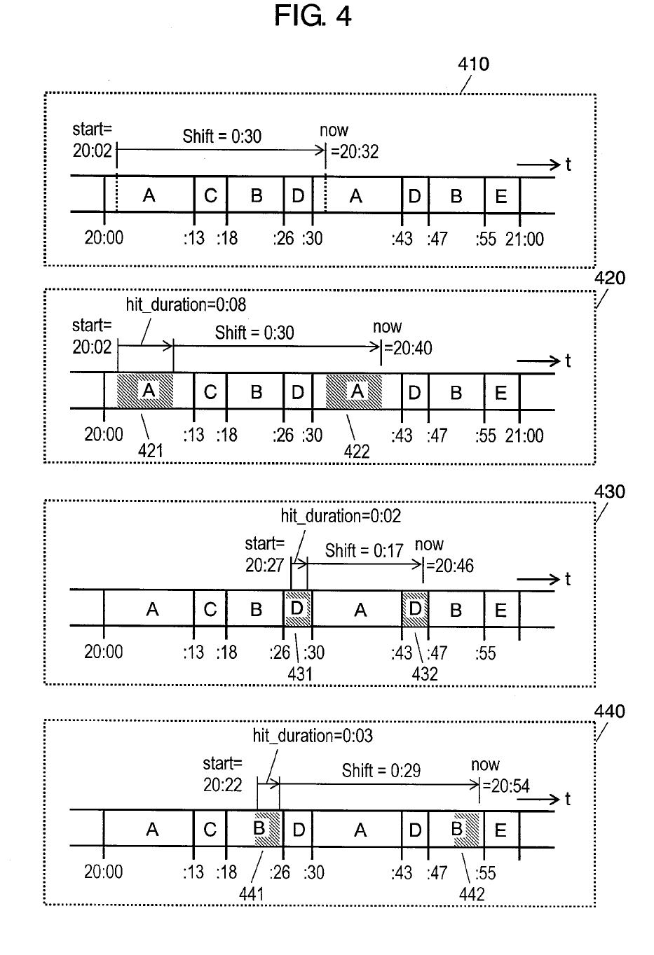

Next, determination on whether or not contents to be transmitted are identical with each other will be described in detail with reference to FIG. 4.

FIG. 4 is a view showing an example of broadcast schedule information according to the first embodiment of the invention. To simplify description of the flow chart shown in FIG. 2, the same broadcast schedule information is divided into four parts.

A horizontal band is a schematic diagram showing times at which contents perceivable by a user are transmitted through a particular transmission path and times at which contents overlap with each other are repeated. That is, aright direction in the horizontal band corresponds to a time traveling direction, and transmission time is marked below the horizontal band. Numbers prefixed with colon “:” represent only minutes with hours omitted.

In the horizontal band, rectangles confined by vertical lines represent contents. The same alphabets in the rectangles represent contents that are identically perceivable by a user.

Broadcast schedule information 410 corresponds to entry 311 of search information 310 shown in FIG. 3. The same contents A as input video and audio are transmitted at times of 20:00 to 20:13 and 20; 30 to 20:43. Here, at a point of time when a current time “now” reaches 20:32 for a time “start” (=20:02) of entry 311 of search information 311, it is determined in Step S210 that videos or audios at two minutes after start of the same contents A are identical with each other.

A value of (now−start) is put in “shift.” Then, the process returns to Step S203 (Step S211).

If it is determined in Step S208 that input videos or audios of entries selected in Step S203 are not identical with each other (is_hit is False), and if it is determined in Step S210 that the input videos or audios are identical with each other, the process proceeds to Step S211. That is, it is determined that the selected entries are first identical with each other this time.

As a result of the comparison between the current time “now” and the time “start” in Step S209, a time shift is {now−start}, which is stored in “shift.”

In broadcast schedule information 410 shown in FIG. 4, since the time “start” is 20:02 and the current time “now” is 20:32, a time shift of 30 (minutes) (=20:32−20:02) is put in “shift.”

True is put in is-hit (Step S212). Then, the process returns to Step S203. This is carried out to indicate that it is determined that the selected entries are identical with each other.

A value of (now−start−shift) is put in “hit_duration” (Step S213). That is, this indicates that videos or audios are identical with each other between the time “start” and a time “start+hit_duration” and between a time “now−hit_duration” and the current time “now.”

In broadcast schedule information 420 shown in FIG. 4, since the time “start” is 20:02 and the current time “now” is 20:40 and the time shift is 30 minutes, 8 (minutes) (=20:40−20:02−30) is put in “hit_duration.” Shaded portion 421 (that is, a time between 20:02 and 20:10) and shaded portion 422 (that is, a time between 20:32 and 20:40) indicate time intervals for which videos or audios are identical with each other. At this time, information of entry 321 is stored in search information 320.

Video comparing unit 102 compares the current time “now” and the time “now−shift” to determine whether or not videos or audios are identical with each other (Step S214).

Step S213 is performed when it is determined in Step S208 that the selected entries are identical with each other. Instead of the current time “now” and the time “now−shift,” a comparison time may be adjusted such that videos or audios stored in comparison video storing unit 101 can be compared with each other.

The process proceeds to Step S216 if it is determined in Step S214 that videos are not identical with each other, and, otherwise, proceeds to Step S203 (Step S215).

A value of False is put in “is_hit” (Step S216). Although it has been hitherto determined that videos or audios are identical with each other, since it is determined in Step S214 that videos or audios are not identical with each other, a value of False is put in “is_hit” to indicate that it is determined that videos or audios are not identical with each other.

Referring to FIG. 3, at this time, search information is as entry 331 of search information 330.

With a time deviated by “shift” from the time “start,” a range within which the same videos fall is searched (Step S217). For each entry of the search information, a value of “start” is set by putting “now” in “start” in Step S207. However, if an interval of “start” between entries is wide, since start of an interval of the same videos or audios may not be identical with “start,” there is a possibility that a range in which videos or audios are identical with each other exists although a time retrogresses from “start.”

In Step S217, for a time “start−β” and a time “start+shift−β,” a range of β in which input videos or audios are identical with each other is searched with increase of a value from 0 in order. The search range of β is previous to “start” of the entries selected in Step S203, and has a value of an entry having the closest “start.”

Referring to FIG. 4, since a time can retrogress from 20:02 of “start” up to 20:00 of a head of contents A, 2 (minutes) is obtained as a value of β.

A union of ranges searched in a retrogression direction in Step S217 is taken and merged into the same region information (Step S218). Then, the process returns to Step S203.

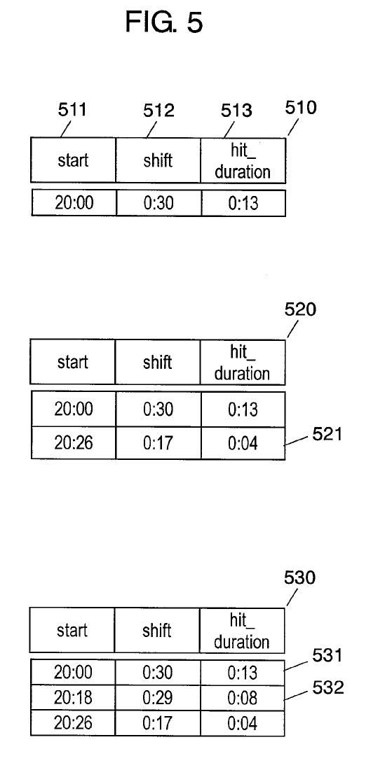

FIG. 5 is a view showing an example of the same region information according to the first embodiment of the invention. The same information region is data representing the same regions, which is the same temporal portion of videos or audios of interest, as one entry in a table format. Each of the same regions has a column of start 511, a column of shift 512 and a column of hit_duration 513. The same kind of contents for the same name as search information is stored. However, a difference of the same region information with the search information is that a plurality of entries temporally adjacent to each other and determined to be identical with each other by the search information may be merged into a single entry in the same region information.

For entry 331 of search information 330 and β (=2 (minutes)) obtained in Step S217, a value retrogressed by β (=2 (minutes)) from “start” (=20:02) is put in “start,” as shown in the same region information 510. For hit_duration, 13 minutes obtained by increase by β from 11 minutes of entry 331 of search information 330 are put in an entry of the same region table.

By performing the steps from Steps S205 to S218 for the entries of the search information selected in Step S203, the search information is being completed.

Entry 341, entry 342 and entry 343 of search information 340 are made for contents A.

For contents D, entry 344 of search information 340 is prepared corresponding to broadcast schedule information 430 shown in FIG. 4, and entry 352 of search information 350 is finally obtained. Entry 521 of the same region information is added.

For contents B, entry 351 of search information 350 is prepared corresponding to broadcast schedule information 440 shown in FIG. 4, and entry 361 of search information 360 is finally obtained. Entry 532 of the same region information is added.

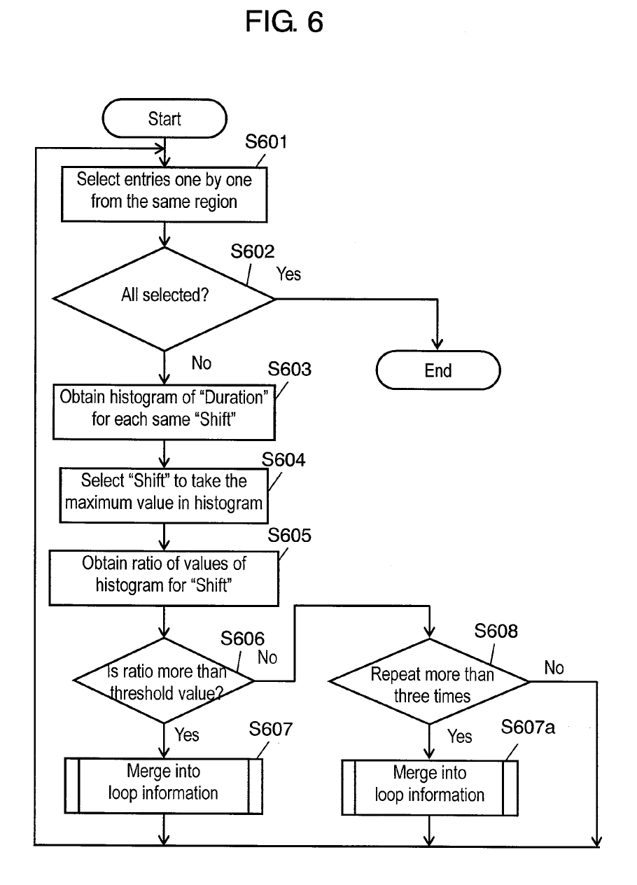

Next, an operation of loop detecting unit 103 will be described in detail with reference to FIGS. 6, 7 and 8. Loop detecting unit 103 receives a result of the determination of video comparing unit 102 and detects loop information which is periodical same information appearing between videos or between audios.

FIG. 6 is a flow chart of a process of generation of loop information according to the first embodiment of the invention (Step S601).

Entries are selected one by one from the same region information.

Since selection of all entries from the same region information is completed in Step S601, the process is ended if there is no entry to be selected in Step S601 (Step S602) which is immediately before performed.

For the same region information, a histogram of “duration” is obtained for each of same “shifts” (Step S603).

At this time, a histogram is obtained with a similar value of “shift” as the same value. This allows reliable detection of “shift” of entries of the search information even if times at a contents transmission side are varied or “shift” has a discrete value.

A value of “shift” to have the maximum value in the obtained histogram is obtained (Step S604).

A ratio of values of histograms for “shift” is obtained (Step S605).

The process proceeds to Step S607 if the ratio obtained in Step S605 exceeds a threshold value, and, otherwise, proceeds to Step S608 (Step S606).

If the ratio is close to 100%, it corresponds to a case where a series of contents which are very similar to each other appears adjacent to each other in a temporal manner.

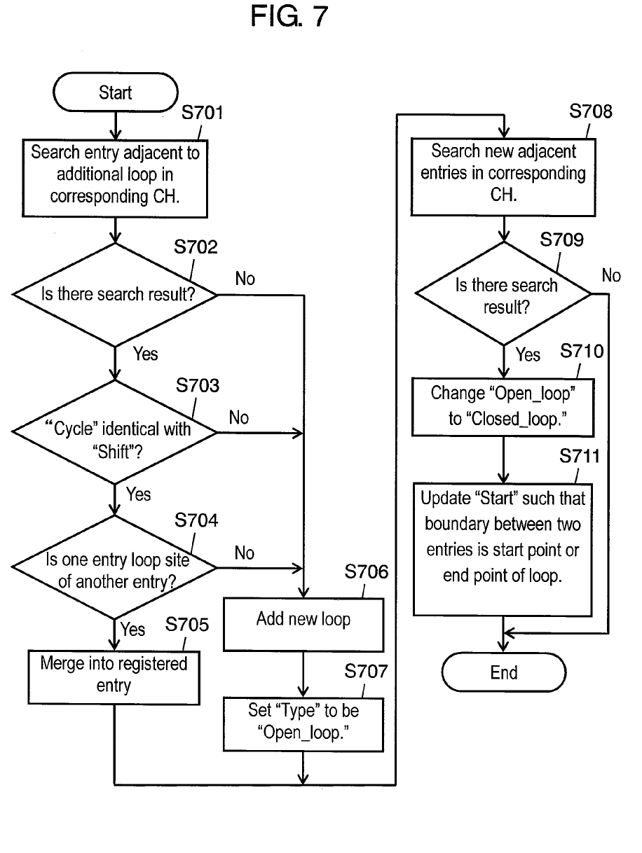

The same region information having “shift” obtained in Step S604 is merged into the loop information (Step S607). Then, the process returns to Step S601. A process of merging the same region information into the loop information will be described later with reference to FIG. 7.

The process proceeds to Step S607a if Step S606 is repeated more than three times in Step S608, and, otherwise, proceeds to Step S601 (Step S607).

Even if the process proceeds to Step S608 since it is determined in Step S606 that the ratio is smaller than the threshold value, that is, a loop is rejected, it is assumed that a loop is detected if it can be confirmed that repetition is periodically made sufficient times.

Next, Step S607 will be described in more detail with reference to FIG. 7.

FIG. 7 is a flow chart of a merge process of loop information according to the first embodiment of the invention.

An entry adjacent to a loop added to a corresponding transmission path (channel) is searched from loop information (Step S701).

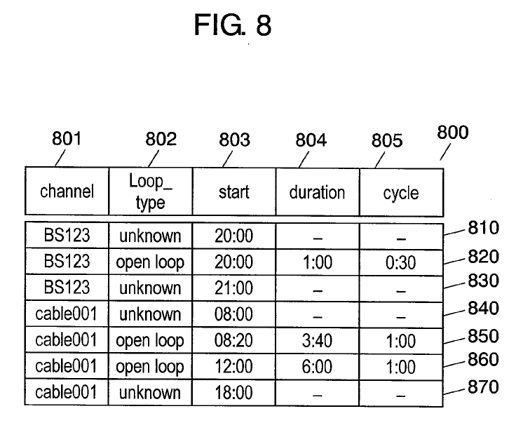

FIG. 8 is a view showing an example of loop information according to the first embodiment of the invention. Each row in the loop information represents information having a table format corresponding to a loop of contents. The loop information presents information on loops for a plurality of transmission paths.

Each entry of loop information 800 includes a column of channel 801, a column of loop_type 802, a column of start 803, a column of duration 804 and a column of cycle 805.

The column of channel 801 stores information specifying a transmission path to discriminate which loop corresponds to which transmission path.

The column of loop_type 802 represents the kind of loop. Values stored in the column of loop_type 802 are “open_loop,” “close_loop” and “unknown.”

“open_loop” represents a state where a loop is known to exist but it is unknown when the loop starts as contents. This value is a default value when an entry is newly added to the loop information.

“close-loop” is the same as “open_loop” except that it is known when the loop starts as contents.

“unknown” represents an entry of pseudo loop information. An “unknown” loop is used to discriminate whether times before and after a time when a loop can be detected are not yet processed in FIG. 6 or whether the times are not loops in the end although processed in FIG. 6. For the latter, an entry whose value of “loop_type” is “unknown” is added to the loop information.

The column of start 803 is a start time of a loop. If a value of “loop_type” is “close_loop,” a time at which repetition of the loop starts is stored in the column of start 803. If a value of “loop_type” is “open_loop,” a time included in repetition of the loop is stored in the column of start 803.

The column of duration 804 is a time length covered by repetition of a series of contents determined to have the same loop.

The column of cycle 805 is an interval (period) with which a loop appears.

The process proceeds to Step S703 if there is a result of search at Step S701, and, otherwise, proceeds to Step S706 (Step S702).

The process proceeds to Step S704 if “cycle” coincides with “shift,” and, otherwise, proceeds to Step S706 (Step S703). Here, by determining that “cycle” coincides with “shift” although “cycle” is a little different, there is a case where loop detection can be prevented from failing.

For example, in the same region information 530, although entry 531 and entry 532 have different loops of 30 minutes and 29 minutes, by accepting a difference of 1 minute or so between “shift” and “cycle,” one repetition length (cycle) is merged in to an entry of 30 minutes in entry 820 of loop information 800.

The process proceeds to Step S705 if one of an entry of the loop information searched in Step S701 and an entry of similar region information to be merged has a temporal portion common to a loop site of the other, and, otherwise, proceeds to Step S706 (Step S704). Here, the loop site refers to one of repetitions included in the same loop.

The entry having the common temporal portion is merged into a registered entry (Step S705). Then, the process proceeds to Step S708. Since two loops have identical “cycle” and temporally overlapping portions, the process enters this step if it is determined that the two loops are the same (Step S706).

Entries of the loops are newly added to the loop information.

It is determined that one of a case where there is no adjacent loop (a case where the process enters Step S706 from Step S702), a case where “cycle” do not coincide with each other (a case where the process enters Step S706 from Step S703), and a case where one entry does not overlap with another entry temporally (a case where the process enters Step S706 from Step S704) is different from a loop currently registered, and then, the entry of the loop is newly registered as an entry of a new loop.

A Type is set to be “open_loop.” Then, the process proceeds to Step S708 (Step S707).

In the process of FIG. 7, it is searched whether or not adjacent entries appear newly in a corresponding CH (Step S708). Here, the adjacency refers to that times are adjacent to each other without any gap although there is no temporal common portion including a loop site.

The process proceeds to Step S710 if there is a result of search in Step S708, and, otherwise, is ended (Step S709).

In one set of entries obtained in Step S708, if there is a type having a value of “open_loop,” the value is changed to “closed_loop” (Step S710). If different loops exist adjacently as a series of contents, it is determined that the time is an end point of a loop immediately before the time and a start point of the loop immediately after the time.

A value of “start” is updated such that a boundary contacting the one set of entries obtained in Step S708 becomes a start or an end of a loop (Step S711). Then, the process is ended.

Next, controller 104 will be described. Controller 104 controls the same scene detecting apparatus 100 as a whole. Controller 104 processes interaction of a user with a GUI (Graphic User Interface) that changes a graphic video (OSD: On Screen Display) displayed on a screen according to a user's manipulation inputted from input unit 108. Controller 104 may be a microcomputer including a CPU (Central Processing Unit), a semiconductor memory and so on. Loop information outputted from loop detecting unit 103 is used for the interaction.

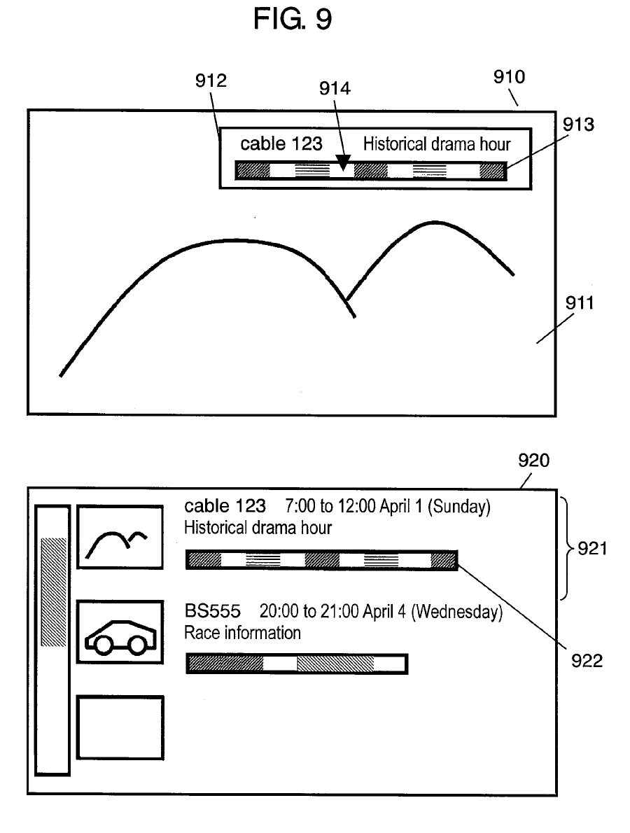

FIG. 9 is a view showing an example of screen display according to the first embodiment of the invention. In FIG. 9, banner display screen 910 shows banner 912 overlay-displaying with the presentation of videos and audios, which are decoded in decoding unit 107, in the entire surface 911 of the display unit 110. Banner 912 shows information additional to videos and audios which are being currently watched.

For example, the additional information includes information on a transmission path (broadcast channel) through which videos and audios are transmitted, titles, temporal positions at which recorded data are decoded, and temporal arrangement of the same contents included in videos and audios.

In FIG. 9, a horizontal direction of band 913 indicating temporal arrangement of the same contents corresponds to a time axis of videos and audios being decoded in a horizontal direction. Band 913 is divided into a plurality of regions by coloring in a time axial direction. Portions having the same color, shape or shade in the plurality of regions represent the same contents.

Band 913 may indicate videos and audios at a time on a screen. By properly scrolling the contents in a horizontal direction, it is possible to indicate the contents with good visibility even when the same contents are subdivided. Alternatively, a band to be scrolled in a horizontal direction and a band to indicate the whole may be displayed simultaneously or displayed in a switchable manner.

Temporal location of videos and audios being currently decoded in the entire surface 911 is expressed by a relative position relationship between cursor 914 and band 913. Controller 104 detects where the same contents are arranged by referring to the same region information, and instructs OSD generating unit 109 to draw band.

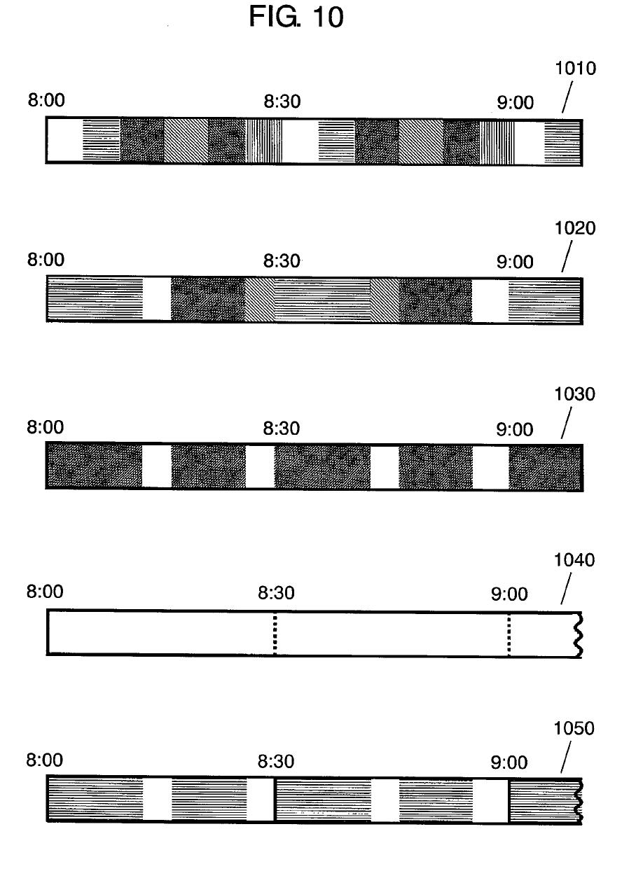

Here, another example of band will be described with reference to FIG. 10.

FIG. 10 is a view showing another example of display of the same contents according to the first embodiment of the invention. FIG. 10 shows an example of five kinds of screen representations corresponding to the broadcast schedule information shown in FIG. 4. In FIG. 10, band 1010 is an example of band by background circulation. Band 1010 by back circulation is repeated in order of determined colors or shapes to draw a time axial direction. The order of colors or shapes uses an order of colors or shapes which seem difficult to know a start point and an end point, including repeated portions. Band is colored in such a manner that colors or shapes make around in synchronization with a period of a loop of the contents.

Although a user know a circulating period at the sight of band 1010 by background circulation, he/she can not know a start point and an end point in a time axis of the band.

Although it has been illustrated for the purpose of brevity that colors or shapes are discretely varied, a gradation may be used in which colors or shapes are continuously varied in the time axis of the band. A periodical waveform such as a triangular waveform or a sinusoidal waveform may be indicated in the band in synchronization with a period of a loop.

Band 1020 is an example of band in which the same contents have the same color or shape. In FIG. 4, Contents A, B and D are deeper in color in order. Contents C and E having the same contents are not colored.

In this manner, the coloring of the contents with the same color has an advantage in that it is ease to intuitively perceive where the same contents are arranged from screen display.

Band 1030 is an example of band in which the same contents has one kind of color or shape. In a case where many same contents exist in one band or the same contents are much shorter than a size of the band, there is a possibility that visibility is lowered if the same contents have different colors or shaped. However, band 1030 can prevent visibility from being lowered.

In addition to dividing and drawing a background color, boundary lines may be drawn at temporal positions of a band whose background color is varied.

In combination with display by background circulation in band 1010, portions that do not coincide with elsewhere may be colored or not.

In combination with display of band 1020, the same contents having fine temporal intervals to a certain degree may be colored with the same color or shape.

If a start point and an end point of repetition of a loop are known, band 1040 is used to express with a design to divide the start point and the end point in a time axial direction of the band. If a value of “loop_type” in loop information is “close_loop,” the start point and the end point of the repetition of the loop occur at a time (start+N*cycle) of a range from “start” to “start+duration.” Where, N is an optional integer and “*” is a product operator.

Band 1050 is an example of combination of the design to divide the start point and the end point of repetition of the loop in band 1040 with the coloring of the same content in band 1030. Similarly, band 1050 may be displayed in combination with band 1010 and band 1020.

Next, an example of a list display screen of recorded videos and audios will be described.

In FIG. 9, list table screen 920 indicates a plurality of lists of recorded videos and audios. List display 921 displays one recording in which a transmission path (broadcast channel), a recording date, a title and so on are indicated. One of the bands shown in FIG. 10 is also indicated in list display 921. Here, any of bands shown in FIG. 10 may be used.

Next, an example of program table display will be described.

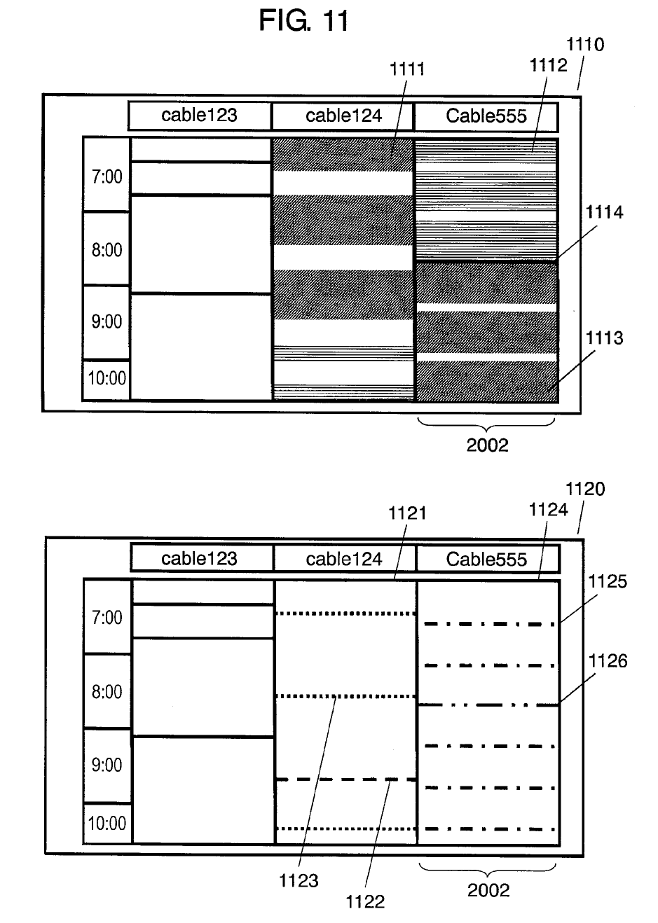

FIG. 11 is a view showing an example of display of a program table according to the first embodiment of the invention. Here, it is assumed that a past program table is displayed, or the same region or loop included in videos and audios previously transmitted is detected by being broadcast at the same time every day.

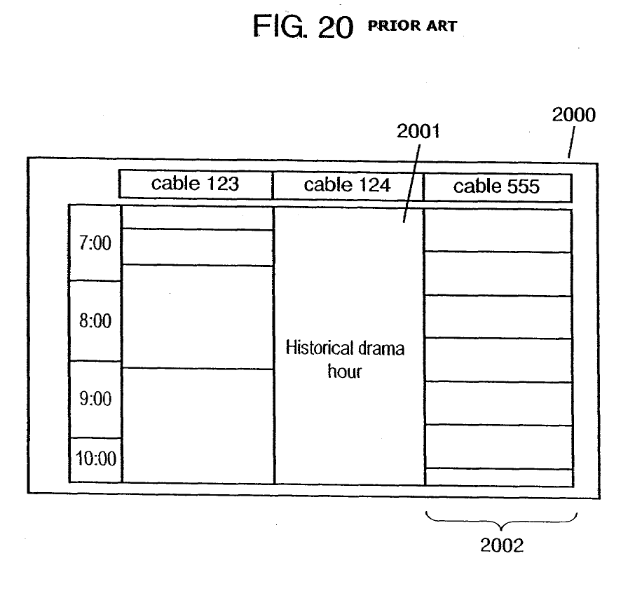

FIG. 11 shows screens to which the technique of the invention is applied, based on screen 2000 shown in FIG. 20. While conventional program 2001 is indicated in one rectangle, program 1111 shown FIG. 11 is indicated with the same contents colored in the same color. Accordingly, it is ease to perceive overlapping of contents in the program display. By marking and moving a focus on only one of the same contents and making reserved recording for the focused contents, it is possible to make recording for necessary and sufficient contents.

Alternatively, the screens shown in FIG. 11 may be applied to “home server” that records most of past broadcastings in advance and prepares for later decoding. In this case, only by moving a focus to select contents, it is possible to display a past program table, display a band for a recorded program, permanently conserve only a desired portion of contents, store the desired portion in a different storage medium, or watch the desired portion. Accordingly, it is not necessary to repeat a fast forward or a rewinding playback to find out desired video and audio as conventional.

Although display for transmission path 2002 shown in FIG. 20 is divided into different programs as EPG data, which programs are identical with each other can not be known until a user watches the programs. On the contrary, as shown in FIG. 11, by coloring the same contents with the same color and displaying design 1114 in portions in which a loop is varied, it is possible to represent times at which contents are varied. A user who wishes to watch all contents once may select programs one by one from top and bottom of design 1114 without watching and selecting all programs of the transmission path 2002.

Screen 1120 is an example of program table display that represents change points of the same contents by drawing boundary lines, instead of coloring a background color. Here, like band 1040 shown in FIG. 10, it is assumed that “loop_type” of a loop is “close_loop” and a start point and an end point of repetition of the loop is known. The start point and the end point of the repetition of the loop is drawn by fine dotted line 1123, and a boundary entering a different loop is drawn by coarse dotted line 1122.

For transmission path 2002 through which EPG data are originally transmitted as different programs, boundaries with the same contents are represented by alternate long and short dash line 1125, and different contents portions are represented by alternate long and two short dashes line 1126.

### Second Embodiment

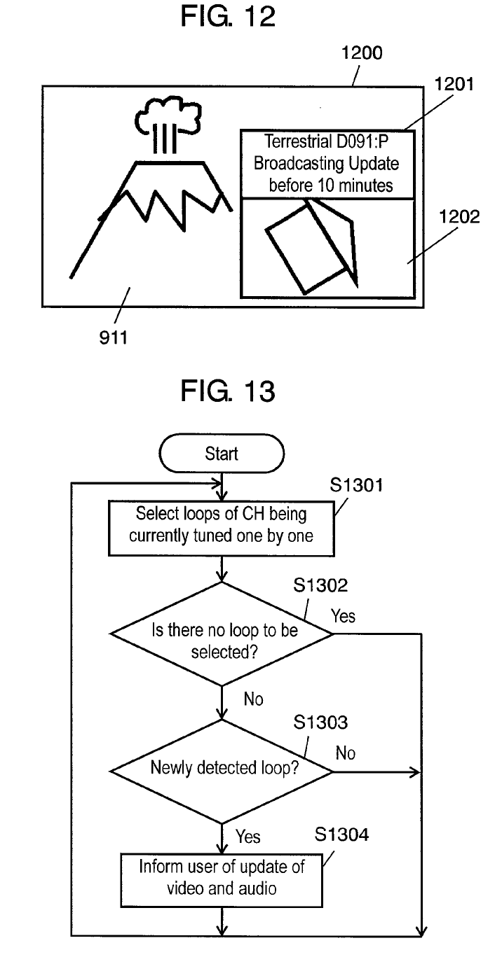

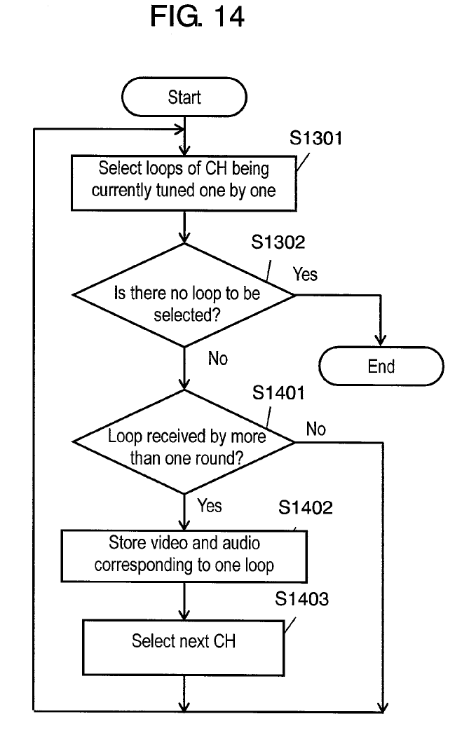

A second embodiment of the invention will be described with reference to FIGS. 12 and 13.

The second embodiment of the invention relates to a method of detecting change of old contents into new contents while videos and audios are being received, recorded and decoded in real time, and presenting the detected change to a user.

The process of generating loop information using the flow charts of the first embodiment shown in FIGS. 2, 6 and 7 can be likewise applied to the second embodiment. The configuration of the same scene detecting apparatus of the first embodiment shown in FIG. 1 can be likewise applied to the second embodiment, and therefore, a difference with the first embodiment will be hereinafter described.

FIG. 12 is a view showing an example of a notification screen of content update according to the second embodiment of the invention. In screen 1200, videos and audios recorded in comparison video storing unit 101 are decoded and displayed in the entire surface 911. While a user watches the videos and audios on the entire surface 911, if it is detected that the watched videos and audios are changed into new contents, pop-up windows are overlay-displayed on screen 1200.

Here, a name of a different transmission path through which the new contents are transmitted, and a contents update time are indicated in pop-up window 1201. Videos and audios transmitted through the transmission path are displayed in Picture-In-Picture in pop-up window 1202.

Next, a process of realizing display shown in FIG. 12 will be described in detail.

FIG. 13 is a flow chart of a process of detection of content update according to the second embodiment of the invention.

Entries regarding a pair of CHs being currently tuned are selected one by one from loop information (Step S1301).

Since selection of all loops is completed in Step S1301, the process returns to Step S1301 if there is no entry to be selected in Step S1301 (Step S1302) which is immediately before performed. Otherwise, the process proceeds to Steps S1303.

The process proceeds to Step S1304 if a new loop is detected, and, otherwise, proceeds to Step S1301 (Step S1303).

There are several methods of determining whether or not there is a newly detected loop.

A first method is to determine that a channel (transmission path) as an object in Step S710 of the flow chart of generating the loop information in FIG. 7 is a new loop.

A second method is to expect that videos and audios received in a range from the time “start+duration” to the time “start+duration+cycle” are the same as those received in a range from the time “start” to the time “start+cycle” in a corresponding entry of loop information. In addition, there is a method of monitoring entries of the search information generated in FIG. 2 and determining that an entry enters a new loop at a point of time when it is determined that the videos or audios are not identical with each other, unlike the expectation.

The last method has an advantage in that a user can be immediately informed of update of an entry although the entry may be detected even in a case where the number of repetitions of a loop is less than a predetermined number.

Controller 104 instructs OSD generating unit 109 to generate screen 1200 (Step S1304). When screen 1200 is displayed on display unit 110, a user is informed of update of contents. Then, the process returns to Step S1301.

A process of generating loop information for videos and audios being received in receiving unit 106 may be performed such that only information 1201 on programs is displayed without displaying videos in Picture-In-Picture on pop-up window 1202 in screen 1200. By generating chime sound, a user can be informed of update of contents of videos and audios being currently watched. The chime sound allows a user not to miss updated contents even while he/she is doing another work, for example, housework, without gazing at display unit 110 with the apparatus powered on.

If receiving unit 106 has the ability to receive a plurality of transmission paths at once, it is possible to detect an update to new contents for videos and audios of the transmission path displayed on screen 911 and a different transmission path, thereby allowing Picture-In-Picture display.

Alternatively, as a notification method, it may be considered that a screen is automatically displayed on display unit 110 at a timing of notification, luminance of videos displayed on display unit 110 is changed from a low state to a high state, or volume of audios is changed from a low level to a high level.

In particular, a controller constituted by a CPU, a memory and so on works to receive EPG data and so on, under a condition where an infrared signal for power-off is received from a remote controller, in home appliances such as a digital TV, but the controller does not work in other display devices such as CRT, PDP, LCD and the like. Such a condition is called “standby mode”.

At this time, new contents are detected in the standby mode, and the standby mode is changed to a normal power mode at a timing of notification after detection. If new contents are not detected, the normal power mode is automatically changed to the standby mode.

In general, since power consumption in the standby mode is significantly lower than that in the normal power mode, it is possible to reduce power consumption as a whole.

### Third Embodiment

A third embodiment of the invention will be described with reference to FIG. 14.

The third embodiment of the invention relates to a process of finishing a tour for videos and audios, which do not belong to the same loop, of videos and audios transmitted through a plurality of transmission paths, as much as possible in a short time. This is realized by automatically switching between receiving transmission paths.

Since channel selection is automatically switched when overlapping videos and audios appear, the minimum of time is required to watch or store much videos and audios. This allows reduction of troublesomeness of a user, saving of capacity required for storage, and the total amount of power required for recording.

The process of generating loop information using the flow charts of the first embodiment shown in FIGS. 2, 6 and 7 can be likewise applied to the third embodiment. The configuration of the same scene detecting apparatus of the first embodiment shown in FIG. 1 can be likewise applied to the third embodiment, and therefore, a difference with the first embodiment will be hereinafter described.

FIG. 14 is a flow chart of a process of automatic touring for a plurality of transmission paths according to the third embodiment of the invention.

The process proceeds to Step S1402 if it is detected that a loop is received by more than one round, and, otherwise, returns to Step S1301 (Step S1401).

Specifically, in the process of merging into the loop information in the first embodiment shown in FIG. 7, it is determined that a loop is received by more than one round at a timing of the process of newly adding a loop in Step S706.

Input videos and audios corresponding to one loop are stored in comparison video storing unit 101 in a format to be decoded in decoding unit 107 (Step S1402).

At a timing at which it is determined that the loop is received by more than one round in Step S1401, there is a possibility that received videos and audios reach more than two rounds of the loop.

This is not only because the process in Step S1401 is delayed but also because there is a possibility of loop rounds of more than three times after videos and audios begin to be received when the process enters from Step S608 to Step S607a for the merge process of the loop information in the first embodiment shown in FIG. 6.

Although it has been described in the above that the videos and audios corresponding to one loop are stored, videos and audios corresponding to two loops may be stored. With the storage of videos and audios corresponding to two loops, videos and audios corresponding to one loop will be included in a seamless form in the stored storage of videos and audios corresponding to two loops although it is unknown where a head of the loop is. Accordingly, there is an advantage of decoding of videos and audios corresponding to one loop with no seam as long as the head of the loop can show up.

Thereafter, the next CH is selected (Step S1403). Then, the process returns to Step S1301.

### Fourth Embodiment

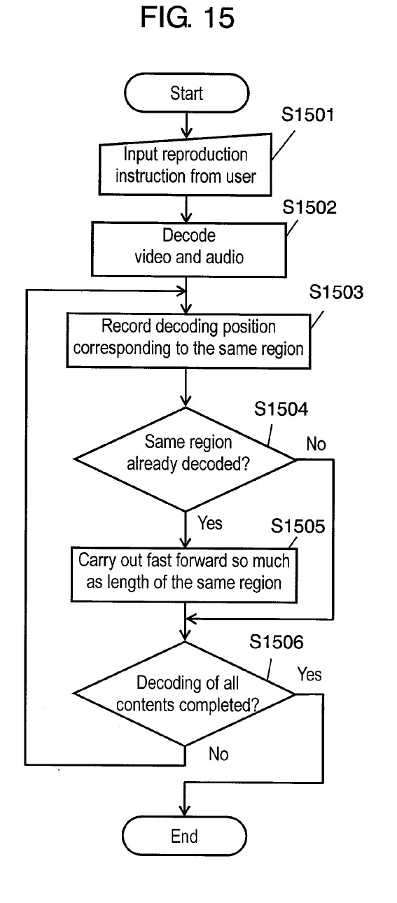

A fourth embodiment of the invention will be described with reference to FIG. 15.

The fourth embodiment of the invention relates to a method of automatically skipping overlapping temporal portions during decoding of recorded videos and audios.

The process of generating loop information using the flow charts of the first embodiment shown in FIGS. 2, 6 and 7 can be likewise applied to the fourth embodiment. The configuration of the same scene detecting apparatus of the first embodiment shown in FIG. 1 can be likewise applied to the fourth embodiment, and therefore, a difference with the first embodiment will be hereinafter described.

FIG. 15 is a flow chart of a process of automatic overlapping skip and decoding according to the fourth embodiment of the invention.

A user inputs an instruction to start decoding of videos and audios through input unit 108 (Step S1501).

Controller 104 instructs decoding unit 107 to decode videos and audios stored in comparison video storing unit 101 (Step S1502).

A temporal position at which the videos and audios are being decoded is recorded corresponding to a corresponding same region (Step S1503).

Based on the information recorded in Step S1503, it is determined whether or not the corresponding same region is a same region that has been already decoded (Step S1504). The process proceeds to Step S1505 if it is determined that the corresponding same region is a same region that has been already decoded, and, otherwise, proceeds to Step S1506.

Fast forward is carried out so much as length of the same region (Step S1505). The same region that has been already decoded is skipped by this step.

The process is ended if decoding of all contents are completed (Step S1506), and, otherwise, returns to Step S1503.

Although it has been described in the above that recorded videos and audios are decoded, streaming decoding via a network may be realized by fast forward playback as long as the same scene or a loop can be detected.

### Fifth Embodiment

A fifth embodiment of the invention relates to a method of automatically skipping overlapping temporal portions during decoding of recorded videos and audios, based on a skip and decoding instruction from a user.

The process of generating loop information using the flow charts of the first embodiment shown in FIGS. 2, 6 and 7 can be likewise applied to the fifth embodiment. The configuration of the same scene detecting apparatus of the first embodiment shown in FIG. 1 can be likewise applied to the fifth embodiment, and therefore, a difference with the first embodiment will be hereinafter described.

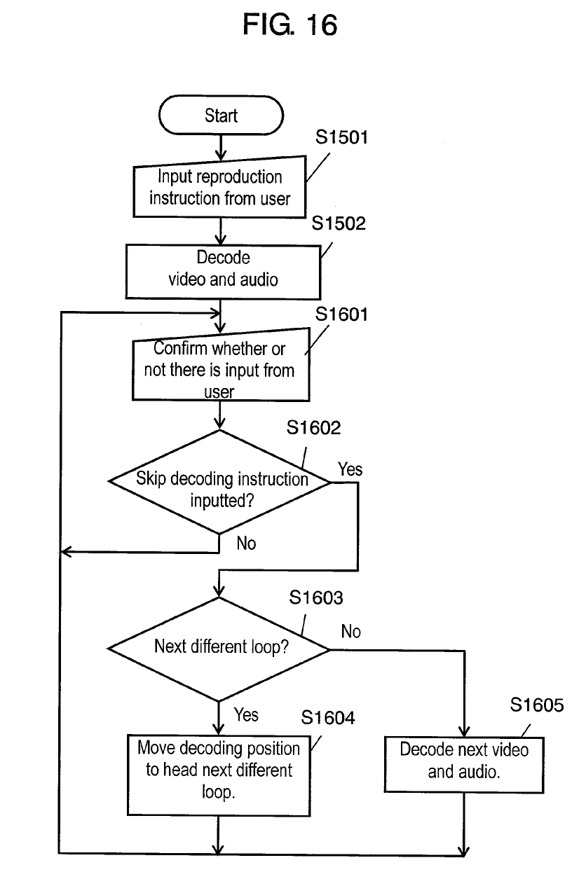

FIG. 16 is a flow chart of a process of manual skip decoding according to the fifth embodiment of the invention.

It is confirmed whether or not there is an input from a user (Step S1601).

The process proceeds to Step S1603 if it is confirmed in Step S1601 that a skip decoding instruction is inputted from the user, and, otherwise, proceeds to Step S1601 (Step S1602).

The process proceeds to Step S1604 if there exists the next different loop, and, otherwise, proceeds to Step S1605 (Step S1603).

A decoding position is moved to a head of the next different loop (Step S1604). Then, the process returns to Step S1601.

The next video and audio is decoded (Step S1605). Then, the process returns to Step S1601.

As described above, although an operation of skipping to the next recording is typically performed, if there exists repetition in one recording, an operation of skipping to the next repetition is performed and then a decoding operation starts. Accordingly, videos and audios, which might have been conventionally skipped and overlooked, will not be overlooked.

A skip decoding operation has been conventionally extended with compatibility with other operations. Accordingly, it is possible for a user to handle an advanced function well without need to learn new manipulation by heart.

### Sixth Embodiment

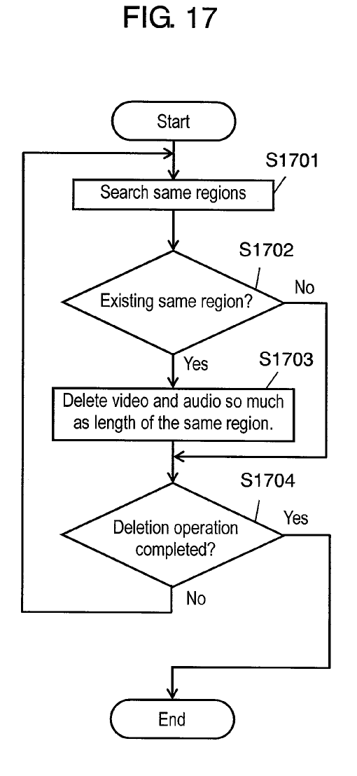

A sixth embodiment of the invention will be described with reference to FIG. 17.

The sixth embodiment of the invention relates to a method of automatically deleting overlapping portions from recorded videos and audios.

The process of generating loop information using the flow charts of the first embodiment shown in FIGS. 2, 6 and can be likewise applied to the sixth embodiment. The configuration of the same scene detecting apparatus of the first embodiment shown in FIG. 1 can be likewise applied to the sixth embodiment, and therefore, a difference with the first embodiment will be hereinafter described.

FIG. 17 is a flow chart of a process of deletion edition of overlapping scenes according to the sixth embodiment of the invention.

The same region is searched from the same region information (Step S1701).

The process proceeds to Step S1703 if the same region is found, and, otherwise, proceeds to Step S1704 (Step S1702).

Videos and audios stored in comparison video storing unit 101 are deleted so much as length of the same region (Step S1703).

In this deletion step, some of substance of the stored videos and audios may be deleted. Alternatively, by editing a play list, some of videos and audios may be deleted in decoding although they exist as data.

The process proceeds to Step S1701 if the deletion operation is completed, and, otherwise, is ended (Step S1704).

Although it has been described in the above that videos and audios are deleted depending on whether or not the same region is present, videos and audios may be deleted only for a loop, based on the loop detection process of the first embodiment shown in FIG. 7. In this case, videos and audios can be correctly deleted in a manner suitable for a transmission path through which videos and audios are repeatedly decoded, such as a Near-VOD, even in a situation where CMs or the like inserted halfway for a short time are varies every time.

### Seventh Embodiment

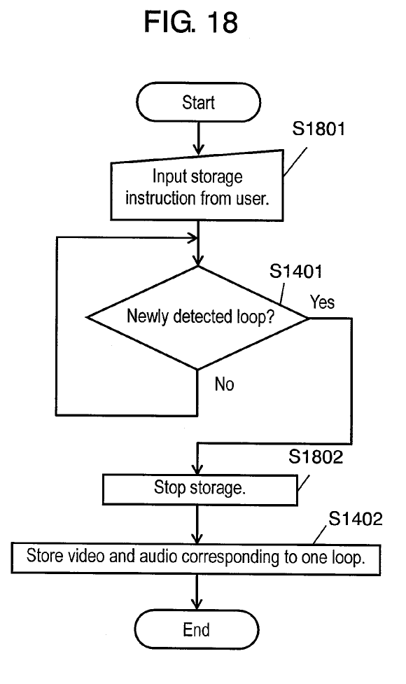

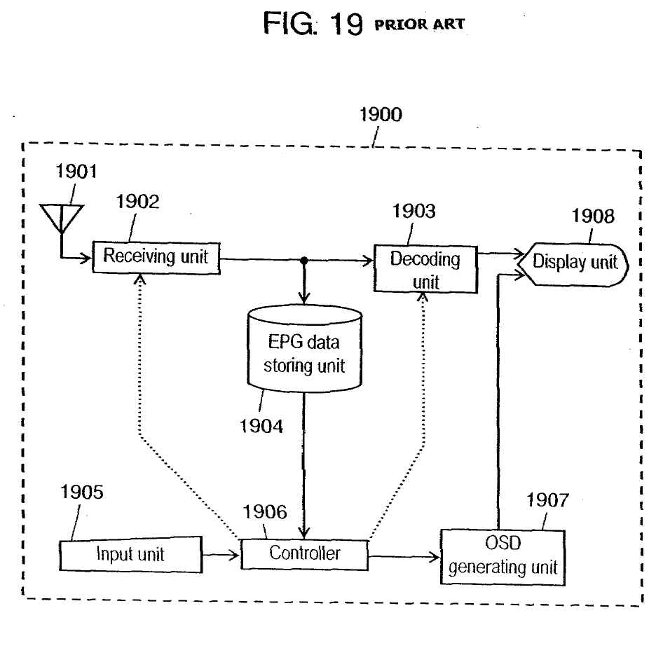

A seventh embodiment of the invention will be described with reference to FIG. 18.

The seventh embodiment of the invention relates to a process of automatically stopping videos and audio recording instructed by a user.

The process of generating loop information using the flow charts of the first embodiment shown in FIGS. 2, 6 and 7 can be likewise applied to the seventh embodiment. The configuration of the same scene detecting apparatus of the first embodiment shown in FIG. 1 can be likewise applied to the seventh embodiment, and therefore, a difference with the first embodiment will be hereinafter described.

FIG. 18 is a flow chart of a process of automatic storage stop according to the seventh embodiment of the invention.

An instruction to store contents is input from a user (Step S1801).

The storage of contents is stopped (Step S1802).

Although it has been described in the above that the videos and audios corresponding to one loop are stored, videos and audios corresponding to two loops may be stored. With the storage of videos and audios corresponding to two loops, videos and audios corresponding to one loop will be included in a seamless form in the stored storage of videos and audios corresponding to two loops although it is unknown where a head of the loop is. Accordingly, there is an advantage of decoding of videos and audios corresponding to one loop with no seam as long as the head of the loop can show up.

Although both of videos and audios are objects watched by a user in the above embodiments, one of videos and audios may be objects watched by the user. For example, if only audios are treated, video comparing unit 102 may be configured in such a manner that an audio is compared with another audio.

In addition, video comparing unit 102 may make determination based on videos and determination based on audios simultaneously and weights results of the determination, thereby increasing accuracy of determination.

In addition, by first performing a process with lower load to set a target of False or True in advance, it is possible to increase an average processing speed and reduce power consumption.

Effects obtained by the same scene detecting method as described above are as follows:

(1) A user can know at the sight of screen display which portions of contents are overlapped and where contents are circulated, without actually watching videos and audios. The user can find a portion that he/she wishes to watch in a short time, thereby saving time taken to search contents.

(2) Since a user is notified of videos and audios that are not overlapped, he/she may not watch the same video and audio repetitively. As a result, the user can watch a variety of information in a short time. Such notification allows the user not to miss new information while watching different contents or even when the user is out of sight of a screen.

(3) In a condition where videos and audios can be received through a plurality of transmission paths, if overlapping portions of the videos and audios are detected in a particular transmission path, the particular transmission path is automatically changed to a different transmission path. Such automatic change of transmission path makes manipulation by a user unnecessary. In addition, a user has no need to determine the sameness of contents, thereby alleviating troublesomeness of the user.

(4) As theme songs, CMs and so on included several times in a Near VOD or a serial drama stored several times are detected as the same scenes, overlapping theme songs and so on are automatically skipped in decoding, thereby alleviating a need to watch lengthy contents to the end.

(5) When a skip decoding button is pushed in decoding of stored contents, overlapping portions of the contents can be skipped to move a decoding position to a position that is not lengthy.

(6) Overlapping scenes included in stored contents can be automatically deleted without confirmation by a user, thereby allowing reduction of watching time, automated edition, reduction of storage area, etc.

(7) When contents are stored in a transmission path on broadcasting in the form of Near VOD, the contents can be automatically repeatedly stored only one time even if a start point and an end point of repetition of the contents are unknown. Accordingly, it is possible to prevent a storage area from being wasted and prevent the contents from being obstructed in storage in a different transmission path since resources for content receipt are not relieved.

### INDUSTRIAL APPLICABILITY

The method and apparatus of the invention are useful in allowing users to watch videos and audios with efficiency in a case where scenes which are temporal portions appeared in the past are included in videos and audios in an apparatus for decoding videos and audios.

Accordingly, the method and apparatus of the invention are useful for televisions or set-top boxes for broadcasting receipt, video recorders of hard disks or DVDs, DVD players and AV viewers for decoding package media, broadband receivers for receiving contents from Internet broadcasting stations, etc.

1. A same scene detecting method comprising the steps of:
detecting same scenes of scenes, which are temporal parts of video or audio, the same scenes being perceived to be identical with each other by a user, and extracting the detected same scenes as a set of same scenes;
obtaining a difference between appearance times of the same scenes included in the set of same scenes;
selecting a set of same scenes having similar appearance times as a same region, the difference of the set of same scenes being close to the same scenes;
determining that the same region is a scene loop having the difference as an appearance period if the sum of time lengths of the same scenes included in the same region exceeds a predetermined value; and
presenting the periodicity.

2. The same scene detecting method of claim 1,
wherein the step of presenting the periodicity comprises presenting video or audio as a figure whose direction corresponds to a time axis and presenting a color, a design or a character circulating repeatedly with the appearance period in correspondence to the time axis on the figure.

3. The same scene detecting method of claim 1,
wherein the step of presenting the periodicity comprises presenting video or audio as a figure whose direction corresponds to a time axis and presenting the same scenes included in the set of same scenes in correspondence of the same color, the same design or the same character to the time axis on the figure.

4. The same scene detecting method of claim 1,
wherein the step of presenting the periodicity comprises presenting video or audio as a figure whose direction corresponds to a time axis and presenting a color, a design or a character for temporal parts having the periodicity in correspondence to the time axis on the figure.

5. The same scene detecting method of claim 1,
wherein the step of presenting the periodicity comprises presenting video or audio as a figure whose direction corresponds to a time axis and presenting divided parts of the periodicity in correspondence of a segment, a design or a character for temporal parts having the periodicity to the time axis on the figure.

6. The same scene detecting method of claim 1,
wherein the step of presenting the periodicity comprises presenting a user that the video or audio at a time of interest is a new scene loop if the video or audio belongs to a scene loop different from a scene loop prior to the time of interest.

7. The same scene detecting method of claim 6,
wherein the step of presenting the periodicity comprises displaying a small window presenting the video or audio relating to the new scene loop at a timing when the time of interest reaches near a current time.

8. The same scene detecting method of claim 6,
wherein the step of presenting the periodicity comprises displaying a design, a color or a character representing a new same scene in combination with a screen on which the video or audio is displayed when the video or audio is presented to a user.

9. The same scene detecting method of claim 6,
wherein the step of presenting the periodicity comprises presenting a time of entrance into a current scene loop or an elapse time.

10. The same scene detecting method of claim 6,
wherein the step of presenting the periodicity comprises changing quality of display in a screen area on which video is displayed.

11. The same scene detecting method of claim 6,
wherein the step of presenting the periodicity comprises changing volume of audio being decoded.

12. The same scene detecting method of claim 1,
wherein the step of presenting the periodicity comprises, if the video or audio can be received through a plurality of transmission paths, changing a corresponding transmission path to a different transmission path when it is detected that the video or audio at a current time is included in an existing scene loop.

13. The same scene detecting method of claim 12,
wherein the step of presenting the periodicity comprises storing the video or audio for each of different scene loops.

14. The same scene detecting method of claim 1, further comprising the step of decoding the video or audio which is stored,
wherein the step of presenting the periodicity comprises using the video or audio being decoded as an input of the step of extracting the set of same scenes, and skipping a decoding position until the video or audio included in one transmission path loop is not included in the transmission path loop.

15. The same scene detecting method of claim 1, further comprising the steps of:
decoding the video or audio which is stored; and
inputting an instruction from a user to progress a temporal decoding position first,
wherein the step of presenting the periodicity using the video or audio being decoded as an input of the step of extracting the set of same scenes, and decoding the video or audio again at a position at which the video or audio included in one transmission path loop is not included in the transmission path loop.

16. The same scene detecting method of claim 1, further comprising the step of decoding the video or audio which is stored,
wherein the step of presenting the periodicity comprises deleting some or all of repeated same scenes in the video or audio which is stored and storing the deleted same scenes again.

17. The same scene detecting method of claim 1, further comprising the step of storing the video or audio,
wherein the step of presenting the periodicity comprises stopping the storage when the same scenes are detected from the video and audio being stored.

18. The same scene detecting method of claim 17, wherein the step of presenting the periodicity comprises stopping the storage at a point of time when the second repetition of the same scenes is completed.

19. The same scene detecting method of claim 17, wherein the step of presenting the periodicity comprises stopping the storage at a point of time when the second repetition of the same scenes is completed, and trimming the video or audio stored by the amount of one round.

20.-39. (canceled)
